(19) United States
(12) Patent Application Publication
(10) Pub. No.: US 2023/0216155 A1
(43) Pub. Date: Jul. 6, 2023

(54) BATTERY

(71) Applicant: KABUSHIKI KAISHA TOSHIBA, Tokyo (JP)

(72) Inventors: Takahiro AIZAWA, Yokohama Kanagawa (JP); Kuniaki YAMAMOTO, Yokohama Kanagawa (JP)

(73) Assignee: KABUSHIKI KAISHA TOSHIBA, Tokyo (JP)

(21) Appl. No.: 18/067,215

(22) Filed: Dec. 16, 2022

(30) Foreign Application Priority Data
Jan. 6, 2022 (JP) 2022-001111

(51) Int. Cl. H01M 50/54; H01M 50/557; H01M 50/536; H01M 50/102

(52) U.S. Cl. CPC H01M 50/54; H01M 50/557; H01M 50/536; H01M 50/102

(57) ABSTRACT

In one embodiment, a battery includes an exterior unit, an electrode group, an electrode terminal, tab bundles and a lead. The electrode group is housed in an interior cavity of the exterior unit, and the electrode terminal is exposed to an outside. Current collecting tabs are stacked in the thickness direction of the electrode group in each of the tab bundles having the same polarity. The tab bundles protrude from the electrode group to the same side in the length direction of the electrode group. The lead establishes an electric connection between the respective tab bundles and the electrode terminal. The tab bundles are bonded to the lead at positions deviated from one another in the thickness direction, and are mounted on the lead from the same side in the thickness direction.

### CROSS-REFERENCE TO RELATED APPLICATIONS

This application is based upon and claims the benefit of priority from Japanese Patent Application No. 2022-001111, filed Jan. 6, 2022; the entire contents of which are incorporated herein by reference.

### FIELD

Embodiments described herein relate generally to batteries.

### BACKGROUND

Batteries, such as lithium ion secondary batteries, include a type in which an electrode group including a positive electrode and a negative electrode is housed in the interior cavity of an exterior unit. In batteries of this type, an electrode terminal is attached to the exterior unit in such a manner as to be exposed to the outside of the exterior unit. Furthermore, a plurality of current collecting tabs of the same polarity protrude from the electrode group toward the same side in the length direction of the electrode group. These current collecting tabs are stacked in the thickness direction of the electrode group intersecting the length direction of the electrode group to form a tab bundle. In the interior cavity, an electric connection is established between the tab bundle of the current collecting tabs and the electrode terminal. The tab bundle of the current collecting tabs is bonded to the lead, for example, through ultrasonic welding.

In a battery including a plurality of current collecting tabs of the same polarity protruding from the electrode group, the number of current collecting tabs tends to increase. For such a battery, multiple current collecting tabs of the same polarity are bundled at several positions to form tab bundles, at each of which current collecting tabs are stacked in the thickness direction of the electrode group. Each of the tab bundles is bonded to a lead, which establishes an electric connection with an electrode terminal.

In a battery in which a plurality of tab bundles are formed by a plurality of current collecting tabs of the same polarity, efficiency of bonding the respective tab bundles to the lead needs to be ensured. In addition, firm bondability of the tab bundles to the lead is also required.

### BRIEF DESCRIPTION OF THE DRAWINGS

FIG. 1 is a perspective view schematically showing a battery according to the first embodiment.

FIG. 2 is a perspective exploded view schematically showing an electrode group, an exterior container, and a lid member of the battery according to the first embodiment.

FIG. 3 is a perspective view schematically showing the structure of the electric connection of the electrode group to one of the paired electrode terminals and the vicinity of the electric connection in the battery according to the first embodiment.

FIG. 4 is a schematic view showing the structure of the electric connection of the electrode group to one of the paired electrode terminals and the vicinity of the electric connection in the battery according to the first embodiment, when viewed from one side in the lateral direction of the battery.

FIG. 5 is a perspective view schematically showing one of the paired leads of the battery according to the first embodiment.

FIG. 6 is a perspective view schematically showing the structure of the boded portions of the tab bundles to one of the paired leads and the vicinity of the bonding portions in a battery according to the first modification.

FIG. 7 is a perspective view schematically showing one of the paired leads in the battery according to the first modification.

FIG. 8 is a schematic view showing the structure of the electric connection of the electrode group to one of the paired electrode terminals and the vicinity of the electric connection in a battery according to the second modification, when viewed from one side in the lateral direction of the battery.

FIG. 9 is a perspective view schematically showing an electrode group and current collecting tabs protruding from the electrode group in a battery according to the third modification.

FIG. 10 is a schematic view showing the structure of the electric connection of the electrode group to one of the paired electrode terminals and the vicinity of the electric connection in a battery according to the fourth modification, when viewed from one side in the depth direction of the battery.

### DETAILED DESCRIPTION

According to the present embodiment, a battery includes an exterior unit, an electrode group, an electrode terminal, a plurality of tab bundles, and a lead. An interior cavity is formed inside the exterior unit. The electrode group includes a positive electrode and a negative electrode, and is housed in the interior cavity of the exterior unit. The electrode terminal is attached to the exterior unit in such a manner as to be exposed to the outside of the exterior unit. Each of the tab bundles includes a plurality of current collecting tabs, and these current collecting tabs are stacked in each of the tab bundles in the thickness direction of the electrode group. The tab bundles have the same polarity, and protrude from the electrode group toward the same side in the length direction of the electrode group intersecting the thickness direction of the electrode group. The lead establishes an electric connection between the respective tab bundles and the electrode terminal in the interior cavity, and the tab bundles are respectively bonded to the lead. These tab bundles are bonded to the lead at positions deviated from one another in the thickness direction of the electrode group, and are mounted on the lead from the same side in the thickness direction of the electrode group.

The embodiments will be described below with reference to the accompanying drawings.

### First Embodiment

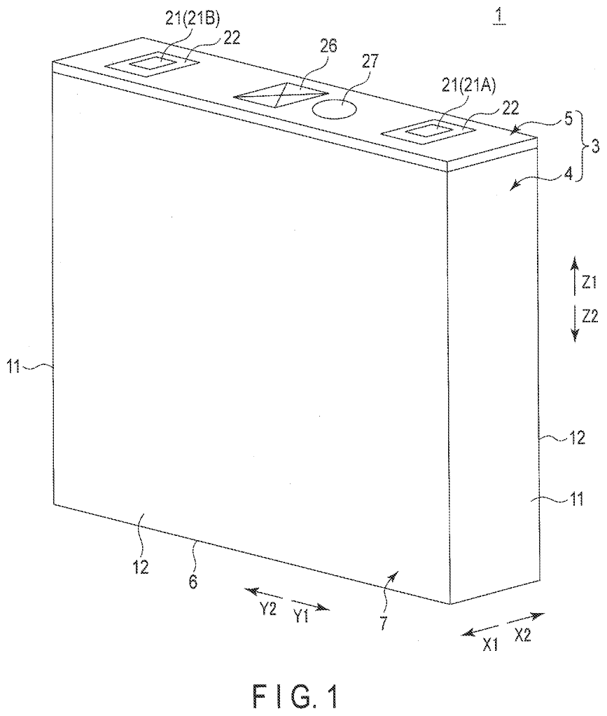

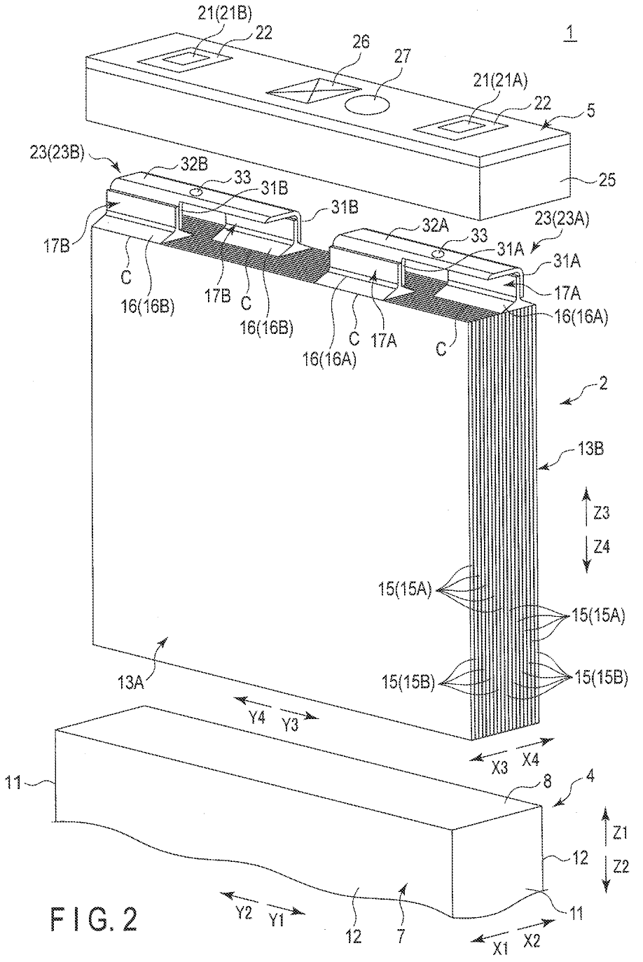

FIGS. 1 and 2 show a battery 1 according to the first embodiment. As illustrated in FIGS. 1 and 2, the battery 1 includes an electrode group 2 and an exterior unit 3. In the example of FIGS. 1 and 2, the exterior unit 3 includes an exterior container 4 and a lid member 5. The exterior container 4 and lid member 5 are formed of metals such as aluminum, aluminum alloy, iron, copper, or stainless steel. For the battery 1 (exterior unit 3), a depth direction (indicated by arrows X1 and X2), a lateral direction (indicated by arrows Y1 and Y2) intersecting the depth direction (in an orthogonal or approximately orthogonal manner), and a height direction (indicated by arrows Z1 and Z2) intersecting both the depth direction and lateral direction (in an orthogonal or approximately orthogonal manner) are defined. In the battery 1 and exterior unit 3 of FIGS. 1 and 2, their dimensions in the depth direction are smaller than each of the dimension in the lateral direction and the dimension in the height direction. FIG. 1 is a schematic perspective view, while FIG. 2 is a perspective exploded view, taking the structure apart into the electrode group 2, exterior container 4 and lid member 5.

The exterior container 4 includes a bottom wall 6 and a peripheral wall 7. An interior cavity 8 is formed inside the exterior unit 3 to house the electrode group 2. In the example of FIGS. 1 and 2, the interior cavity 8 is defined by the bottom wall 6 and peripheral wall 7 of the exterior container 4. In the exterior container 4, the interior cavity 8 is open to the side opposite the side of the bottom wall 6 in the height direction. The peripheral wall 7 includes two pairs of side walls 11 and 12. The side walls 11 face each other in the lateral direction across the interior cavity 8. The side walls 12 face each other in the depth direction across the interior cavity 8. Each of the side walls 11 extends in the depth direction between the two side walls 12. Each of the side walls 12 extends in the lateral direction between the two side walls 11. The lid member 5 is attached to the peripheral wall 7 at an end opposite the bottom wall 6, thereby covering the opening of the interior cavity 8 of the exterior container 4. The lid member 5 and bottom wall 6 face each other in the height direction across the interior cavity 8.

The electrode group 2 includes a positive electrode 13A and a negative electrode 13B. The electrode group 2 includes a separator (not shown) between the positive electrode 13A and negative electrode 13B. The separator of the electrode group 2 is formed of an electrically insulative material so as to electrically insulate the positive electrode 13A from the negative electrode 13B.

The positive electrode 13A of the electrode group 2 includes a positive electrode current collector such as a positive electrode current collecting foil, and a positive electrode active material-containing layer (not shown) supported on the surface of the positive electrode current collector. The positive electrode current collector is, but is not limited to, for example, an aluminum foil or aluminum alloy foil having a thickness of about 5 μm to 20 μm. The positive electrode active material-containing layer includes a positive electrode active material, and may contain a binder and an electro-conductive agent. Examples of the positive electrode active material include, but are not limited to, oxides, sulfides, and polymers that are capable of occluding and releasing lithium ions.

The negative electrode 13B of the electrode group 2 includes a negative electrode current collector such as a negative electrode current collecting foil, and a negative electrode active material-containing layer (not shown) supported on the surface of the negative electrode current collector. The negative electrode current collector is, but is not limited to, for example, an aluminum foil, an aluminum alloy foil, or a copper foil, having a thickness of about 5 μm to 20 μm. The negative electrode active material-containing layer includes a negative electrode active material, and may contain a binder and an electro-conductive agent. Examples of the negative electrode active material include, but are not limited to, a metal oxide, a metal sulfide, a metal nitride, and a carbon material, which are capable of occluding and releasing lithium ions.

In the electrode group 2, a length direction (indicated by arrows Z3 and Z4), a width direction (indicated by arrows Y3 and Y4) intersecting the length direction (in an orthogonal or approximately orthogonal manner), and a thickness direction (indicated by arrows X3 and X4) intersecting both the length direction and width direction (in an orthogonal or approximately orthogonal manner) are defined. The dimension of the electrode group 2 in the thickness direction is smaller than each of the dimension in the length direction and the dimension in the width direction. The electrode group 2 is flatly shaped.

In the example of FIG. 2, the electrode group 2 includes a plurality of electrode plates 15, and these electrode plates 15 are stacked in the thickness direction of the electrode group 2 into a stacked structure in the electrode group 2. As a result, the stacking direction of the electrode plates 15 agrees, or approximately agrees, with the thickness direction of the electrode group 2 in the example of FIG. 2. The electrode group 2 includes as the electrode plates 15, a plurality of positive electrode plates 15A that form the positive electrode 13A and a plurality of negative electrode plates 15B that form the negative electrode 13B, where the positive electrode plates 15A and the negative electrode plates 15B are alternately stacked in the electrode group 2 in the thickness direction of the electrode group 2. In the electrode group 2, a separator is provided between a positive electrode plate 15A and a negative electrode plate 15B adjacent to each other in the thickness direction of the electrode group 2 (i.e., the stacking direction of the electrode plates 15). Each of the electrode plates 15 is arranged in such a manner that the plate thickness direction agrees, or approximately agrees, with the thickness direction of the electrode group 2.

In the battery 1, a plurality of current collecting tabs 16 protrude from the electrode group 2. As the current collecting tabs 16, a plurality of positive electrode current collecting tabs 16A and a plurality of negative electrode current collecting tabs 16B are provided in the battery 1. Each of the positive electrode current collecting tabs 16A is connected to the positive electrode current collector of the positive electrode 13A. The positive electrode current collecting tabs 16A therefore demonstrate the same polarity. The positive electrode current collecting tabs 16A are conductive, and are formed of, for example, the same material as that of the positive electrode current collector. Each of the positive electrode current collecting tabs 16A may be formed integrally with the corresponding one of the positive electrode plates 15A, or may be formed separately from the positive electrode plates 15A. Each of the positive electrode current collecting tabs 16A protrudes from the electrode group 2 toward one side in the length direction of the electrode group 2, and these positive electrode current collecting tabs 16A protrude from the electrode group 2 to the same side in the length direction of the electrode group 2.

Each of the negative electrode current collecting tabs 16B is connected to the negative electrode current collector of the negative electrode 13B. The negative electrode current collecting tabs 16B therefore demonstrate the same polarity. The negative electrode current collecting tabs 16B are conductive, and are formed of, for example, the same material as that of the negative electrode current collector. Each of the negative electrode current collecting tabs 16B may be formed integrally with the corresponding one of the negative electrode plates 15B, or may be formed separately from the negative electrode plates 15B. Each of the negative electrode current collecting tabs 16B protrudes from the electrode group 2 toward one side in the length direction of the electrode group 2, and these negative electrode current collecting tabs 16B protrude from the electrode group 2 to the same side in the length direction of the electrode group 2. Moreover, in the example of FIG. 2, the negative electrode current collecting tabs 16B protrude from the electrode group 2 on the side of the protrusion of the positive electrode current collecting tabs 16A according to the length direction of the electrode group 2. The negative electrode current collecting tabs 16B are separated from the positive electrode current collecting tabs 16A in the width direction of the electrode group 2, and therefore are not in contact with the positive electrode current collecting tabs 16A.

According to the present embodiment, the electrode group 2 is arranged in the interior cavity 8 in such a manner that its length direction matches, or approximately matches, the height direction of the battery 1. In the electrode group 2, its width direction matches, or approximately matches, the lateral direction of the battery 1, and its thickness direction matches, or approximately matches, the depth direction of the battery 1. Furthermore, in the example of FIG. 2, the current collecting tabs 16 (positive electrode current collecting tabs 16A and negative electrode current collecting tabs 16B) protrude from the electrode group 2 in the interior cavity 8, toward the lid member 5 in the height direction of the battery 1. The negative electrode current collecting tabs 16B are separated from the positive electrode current collecting tabs 16A according to the lateral direction of the battery 1.

The electrode group 2 holds an electrolytic solution (not shown) and is impregnated therewith in the interior cavity 8. The electrolytic solution may be an aqueous electrolytic solution such as a water solution, or a non-aqueous electrolytic solution obtained by dissolving an electrolyte in an organic solvent. Instead of the electrolytic solution, a gel electrolyte or a solid electrolyte may be used. If a solid electrolyte is adopted for the electrolyte, this solid electrolyte is provided, in place of the separator, between the positive electrodes 13A and negative electrodes 13B in the electrode group 2. In this case, the positive electrodes 13A are electrically insulated from the negative electrodes 13B by the solid electrolyte in the electrode group 2.

In the battery 1 according to the present embodiment, a pair of electrode terminals 21 are attached to the lid member 5 of the exterior unit 3. The electrode terminals 21 are formed of an electro-conductive material such as a metal. One of the electrode terminals 21 is a positive electrode terminal 21A of the battery 1, while the other electrode terminal 21 that differs from the positive electrode terminal 21A is a negative electrode terminal 21B of the battery 1. The electrode terminals 21 are arranged on the outer surface of the lid member 5, exposed to the outside of the battery 1. The electrode terminals 21 are separated from each other in the lateral direction of the battery 1. An insulating member 22 is provided between each of the electrode terminals 21 and the lid member 5 on the outer surface of the lid member 5. With the insulating members 22, the electrode terminals 21 are electrically insulated from the exterior unit 3 (exterior container 4 and lid member 5).

A pair of leads 23 are arranged in the interior cavity 8 of the exterior unit 3. The leads 23 are formed of an electrically conductive material such as a metal, and examples of the materials of the leads 23 include aluminum, stainless steel, copper, and iron. In the interior cavity 8, the leads 23 are arranged between the electrode group 2 and lid member 5 in the height direction of the battery 1. Each of the leads 23 is integrally formed as one member. One of the leads 23 is a positive electrode-side lead 23A, and the other lead 23 that differs from the positive electrode-side lead 23A is a negative electrode-side lead 23B.

In the interior cavity 8, an electric connection is established between the respective positive electrode current collecting tabs 16A and the positive electrode terminal 21A by way of the positive electrode-side lead 23A. This means that the positive electrode-side lead 23A constitutes at least part of the electric path between each of the positive electrode current collecting tabs 16A and the positive electrode terminal 21A. Furthermore, in the interior cavity 8, an electric connection is established between the respective negative electrode current collecting tabs 16B and the negative electrode terminal 21B by way of the negative electrode-side lead 23B. This means that the negative electrode-side lead 23B constitutes at least part of the electric path between each of the negative electrode current collecting tabs 16B and the negative electrode terminal 21B. The negative electrode-side lead 23B is separated from the positive electrode-side lead 23A in the lateral direction of the battery 1 (the width direction of the electrode group 2). The negative electrode-side lead 23B is therefore not in contact with the positive electrode-side lead 23A.

As described above, since an electrical connection is established for each of the electrode terminals 21 to the electrode group 2, the electrode group 2 is connected to the positive electrode terminal 21A in the battery 1, with the positive electrode current collecting tabs 16A and positive electrode-side lead 23A interposed. The electrode group 2 is also connected to the negative electrode terminal 21B, with the negative electrode current collecting tabs 16B and negative electrode-side lead 23B interposed. Thus, in the battery 1, the positive electrode-side electric connection structure for electrically connecting the electrode group 2 to the positive electrode terminal 21A and the negative electrode-side electric connection structure for electrically connecting the electrode group 2 to the negative electrode terminal 21B are prepared as a pair of electric connection structures. The electric connection structures that are separated from each other in the lateral direction of the battery 1 (width direction of the electrode group 2) are not in contact with each other. The electric connection structures are therefore insulated from each other.

A spacer (electrode group retainer) 25 is arranged in the interior cavity 8 of the exterior unit 3. The spacer 25 is formed of an electrically insulative material. The spacer 25 is arranged between the electrode group 2 and lid member 5 according to the height direction of the battery 1. In the interior cavity 8, the spacer 25 and the like prevent the current collecting tabs 16 (positive electrode current collecting tabs 16A and negative electrode current collecting tabs 16B) and the pair of leads 23 (positive electrode-side lead 23A and negative electrode-side lead 23B) from being in contact with the exterior unit 3 (exterior container 4 and lid member 5). The current collecting tabs 16 and leads 23 are therefore electrically insulated from the exterior unit 3. The spacer 25 also presses the electrode group 2 toward the bottom wall 6 in the height direction of the battery 1, as a result of which the movement of the electrode group 2 along the height direction of the battery 1 is restricted in the interior cavity 8.

In the example of FIGS. 1 and 2, a safety valve 26 and a liquid inlet (not shown) are formed in the lid member 5. Furthermore, a sealing plate 27 is welded to the outer surface of the lid member 5 to seal the liquid inlet. The safety valve 26 and liquid inlet are arranged between the two electrode terminals 21 in the lateral direction of the battery 1. In another example, the safety valve 26 and liquid inlet may not be provided in the battery 1.

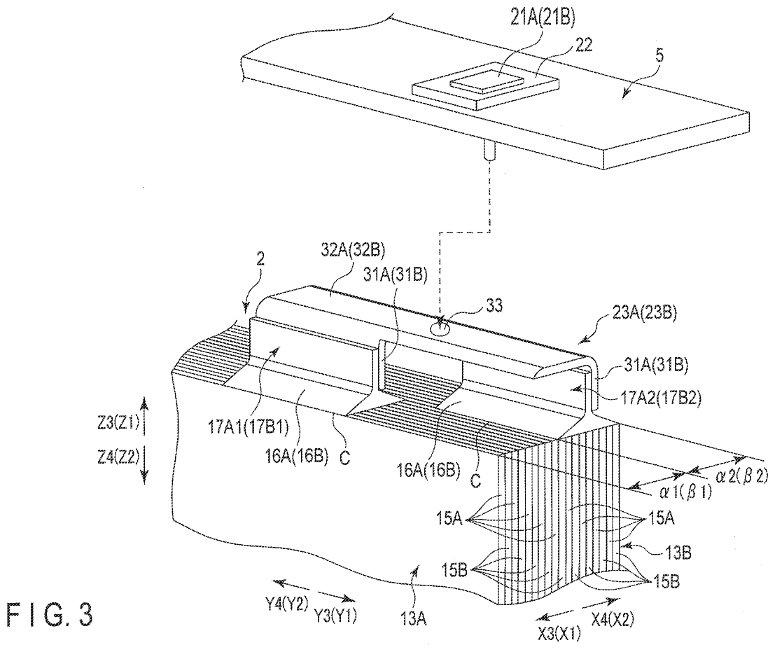

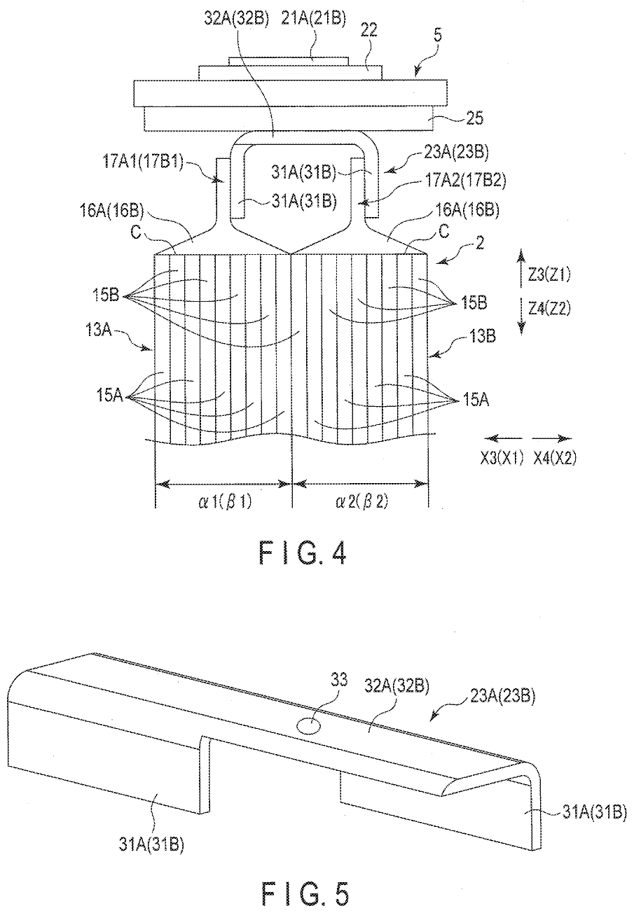

The electric connection structure of the electrode group 2 to each of the electrode terminals 21, or in other words the aforementioned pair of electric connection structures, will be further described below. FIGS. 3 and 4 show the structure of the electric connection of the electrode group 2 to one of the electrode terminals 21 and the vicinity of this connection. The illustrated structure includes one of the paired electric connection structures and its vicinity. FIG. 3 is a perspective view schematically showing the state of the lead 23 not yet connected to the electrode terminal 21, while FIG. 4 schematically shows the state of the battery 1 when viewed from one side of the lateral direction of the battery 1 (width direction of the electrode group 2). FIG. 5 is a perspective view of one of the paired leads 23. In FIGS. 3 and 4, the electric connection structure of the electrode group 2 to only one of the two electrode terminals 21 is depicted; however, the electric connection structure of the electrode group 2 to the other electrode terminal 21 is the same as the electric connection structure of FIGS. 3 and 4. In FIGS. 3 to 5, only one of the paired leads 23 is depicted; however, the other lead 23 has the same structure as that of FIGS. 3 to 5.

As shown in FIGS. 2 to 4, the positive electrode current collecting tabs 16A according to the present embodiment that protrude from the electrode group 2 are bundled at multiple positions to form multiple tab bundles (positive electrode-side tab bundles) 17A. Furthermore, the negative electrode current collecting tabs 16B that protrude from the electrode group 2 are bundled at multiple positions to form multiple tab bundles (negative electrode-side tab bundles) 17B. In the examples of FIGS. 2 to 4, two tab bundles 17A and two tab bundles 17B are formed. In each of the tab bundles 17A, a plurality of positive electrode current collecting tabs 16A are stacked in the thickness direction of the electrode group 2 (depth direction of the battery 1), while in each of the tab bundles 17B, a plurality of negative electrode current collecting tabs 16B are stacked in the thickness direction of the electrode group 2. As a result, the stacking direction of the current collecting tabs 16 in each of the tab bundles 17A and 17B agrees, or approximately agrees, with the thickness direction of the electrode group 2 (depth direction of the battery 1).

The tab bundles 17A, each formed of a plurality of positive electrode current collecting tabs 16A, demonstrate the same polarity. The tab bundles 17B, each formed of a plurality of negative electrode current collecting tabs 16B, also demonstrate the same polarity. The tab bundles 17B have a polarity opposite to that of the tab bundles 17A. Since the tab bundles (negative electrode-side tab bundles) 17B are separated from the tab bundles (positive electrode-side tab bundles) 17A in the lateral direction of the battery 1 (width direction of the electrode group 2), the tab bundles 17B are not brought into contact with the tab bundles 17A.

The tab bundles (positive electrode-side tab bundles) 17A are provided at positions deviated from each other in the thickness direction of the electrode group 2. The tab bundles 17A are also separated from each other in the width direction of the electrode group 2 (lateral direction of the battery 1). The tab bundles (negative electrode-side tab bundles) 17B are provided at positions deviated from each other in the thickness direction of the electrode group 2. The tab bundles 17B are also separated from each other in the width direction of the electrode group 2 (lateral direction of the battery 1).

In the positive electrode-side electric connection structure, each of the tab bundles (positive electrode-side tab bundles) 17A is bonded to the positive electrode-side lead 23A. In the negative electrode-side electric connection structure, each of the tab bundles (negative electrode-side tab bundles) 17B is bonded to the negative electrode-side lead 23B. The tab bundles 17A are joined to the positive electrode-side lead 23A at positions deviated from each other according to the thickness direction of the electrode group 2, or in other words the stacking direction of the positive electrode current collecting tabs 16A. The tab bundles 17B are bonded to the negative electrode-side lead 23B at positions deviated from each other in the thickness direction of the electrode group 2, or in other words the stacking direction of the negative electrode current collecting tabs 16B.

In the example of FIGS. 2 to 4, the tab bundles 17A are bonded to the positive electrode-side lead 23A at positions deviated from each other in the width direction of the electrode group 2. The tab bundles 17B are joined to the negative electrode-side lead 23B at positions deviated from each other in the width direction of the electrode group 2. In the example of FIGS. 2 to 4, the tab bundles 17A and 17B are bonded directly to the corresponding one of the leads 23 without any member interposed. The tab bundles 17A and 17B may be bonded to the corresponding one of the leads 23 through ultrasonic welding or the like.

The tab bundles (positive electrode-side tab bundles) 17A are mounted on the positive electrode-side lead 23A on the same side relative to each other in the thickness direction of the electrode group 2, or in other words on the same side in the stacking direction of the positive electrode current collecting tabs 16A. The tab bundles (negative electrode-side tab bundles) 17B are mounted on the negative electrode-side lead 23B on the same side relative to each other in the thickness direction of the electrode group 2, or in other words on the same side in the stacking direction of the negative electrode current collecting tabs 16B. In the example of FIG. 2, the tab bundles 17B are mounted on the negative electrode-side lead 23B from the side on which the tab bundles 17A are mounted on the positive electrode-side lead 23A according to the thickness direction of the electrode group 2 (the depth direction of the battery 1).

Each of the tab bundles 17A and 17B has a connection portion C to be connected to the electrode group 2. In each tab bundle (positive electrode-side tab bundle) 17A, the connection portion C for connection with the electrode group 2 corresponds to the connection portion to the positive electrode current collector of the positive electrode 13A, while in each tab bundle (negative electrode-side tab bundle) 17B, the connection portion C for connection with the electrode group 2 corresponds to the connection portion to the negative electrode current collector of the negative electrode 13B. In each of the tab bundles 17A and 17B, the connection portion C for connection with the electrode group 2 forms the base of the protruding portion from the electrode group 2.

In the electrode group 2, the connection portions C of the tab bundles 17A are formed in areas different from each other in the thickness direction of the electrode group 2. In the examples of FIGS. 2 to 4, two tab bundles 17A, namely tab bundle 17A1 and tab bundle 17A2, are provided. The connection portion C of the tab bundle 17A1 for connection with the electrode group 2 is formed within an area α1 according to the thickness direction of the electrode group 2, while the connection portion C of the tab bundle 17A2 for connection with the electrode group 2 is formed within an area α2 that differs from the area α1 in the thickness direction of the electrode group 2. The area α2 deviates from the area α1 in the thickness direction of the electrode group 2 (stacking direction of the electrode plates 15), and does not overlap the area α1 according to the thickness direction of the electrode group 2.

In each of the tab bundles (positive electrode-side tab bundles) 17A, the portion for bonding to the positive electrode-side lead 23A is arranged within an area, according to the thickness direction of the electrode group 2 or in other words according to the depth direction of the battery 1, where the connection portion C for connection with the electrode group 2 is formed. In the example of FIGS. 3 and 4, the bonding portion of the tab bundle 17A1 to the positive electrode-side lead 23A is arranged within the area α1, in the thickness direction of the electrode group 2 (stacking direction of the electrode plates 15), where the connection portion C for connection with the electrode group 2 is formed. The bonding portion of the tab bundle 17A2 to the positive electrode-side lead 23A is arranged within the area α2, in the thickness direction of the electrode group 2, where the connection portion C for connection with the electrode group 2 is formed. In each of the tab bundles (positive electrode-side tab bundles) 17A, it is preferable that the bonding portion to the positive electrode-side lead 23A be arranged at the center position, or approximately at the center position, of the area in which the connection portion C for connection with the electrode group 2 is formed, according to the thickness direction of the electrode group 2.

Similarly, in the electrode group 2, the connection portions C of the tab bundles 17B are formed in areas different from each other in the thickness direction of the electrode group 2. In the examples of FIGS. 2 to 4, two tab bundles 17B, namely tab bundle 17B1 and tab bundle 17B2, are provided. The connection portion C of the tab bundle 17B1 for connection with the electrode group 2 is formed within an area β1 in the thickness direction of the electrode group 2, while the connection portion C of the tab bundle 17B2 of the electrode group 2 is formed within an area β2 that differs from the area β1 in the thickness direction of the electrode group 2. The area β2 is deviated from the area β1 according to the thickness direction of the electrode group 2 (stacking direction of the electrode plates 15), and does not overlap the area β1 in the thickness direction of the electrode group 2.

In each of the tab bundles (negative electrode-side tab bundles) 17B, the portion for bonding to the negative electrode-side lead 23B is arranged within an area, according to the thickness direction of the electrode group 2, or in other words the depth direction of the battery 1, where the connection portion C for connection with the electrode group 2 is formed. In the example of FIGS. 3 and 4, the bonding portion of the tab bundle 17B1 to the negative electrode-side lead 23B is arranged within the area β1, in the thickness direction of the electrode group 2 (the stacking direction of the electrode plates 15), where the connection portion C for connection with the electrode group 2 is formed. In the tab bundles 17B, the bonding portion to the negative electrode-side lead 23B is arranged within the area β2, in the thickness direction of the electrode group 2, where the connection portion C for connection with the electrode group 2 is formed. In each of the tab bundles (negative electrode-side tab bundles) 17B, it is preferable that the bonding portion to the negative electrode-side lead 23B be arranged at the center position, or approximately at the center position, of the area in which the connection portion C for connection with the electrode group 2 is formed, according to the thickness direction of the electrode group 2.

As illustrated in FIGS. 2 to 5, the positive electrode-side lead 23A includes a bonding plate 31A for each of the tab bundles 17A, which means that bonding plates 31A whose number corresponds to the number of tab bundles 17A are provided in the positive electrode-side lead 23A. Similarly, the negative electrode-side lead 23B includes a bonding plate 31B for each of the respective tab bundles 17B, which means that bonding plates 31B whose number corresponds to the number of tab bundle 17B are provided in the negative electrode-side lead 23B. The plate thickness direction is defined in each of the boding plates 31A and 31B. Each of the bonding plates 31A and 31B has a pair of main surfaces, and the main surfaces of each of the bonding plates 31A and 31B face in mutually opposite sides according to the plate thickness direction.

In the interior cavity 8, the positive electrode-side lead 23A is arranged such that the plate thickness direction of the bonding plates 31A runs along the thickness direction of the electrode group 2 (the depth direction of the battery 1). With such an arrangement, the main surfaces of each of the bonding plates 31A of the positive electrode-side lead 23A face in mutually opposite sides in the thickness direction of the electrode group 2. In the interior cavity 8, the negative electrode-side lead 23B is arranged such that the plate thickness direction of the bonding plates 31B runs along the thickness direction of the electrode group 2 (the depth direction of the battery 1). The main surfaces of each of the bonding plates 31B of the negative electrode-side lead 23B therefore face in mutually opposite sides according to the thickness direction of the electrode group 2.

In the positive electrode-side lead 23A, each of the bonding plates 31A is bonded to the corresponding one of the tab bundles 17A. Each of the bonding plates 31A is mounted on the corresponding one of the tab bundles 17A on the same side in the thickness direction of the electrode group 2 as other bonding plates 31A are mounted. The bonding plates 31A, whose number is the same as that of tab bundles 17A, are provided at positions deviated from each other in the thickness direction of the electrode group 2. In the examples of FIGS. 2 to 5, the bonding plates 31A are also separated from each other in the width direction of the electrode group 2.

In the negative electrode-side lead 23B, each of the bonding plates 31B is bonded to the corresponding one of the tab bundles 17B. Each of the bonding plates 31B is mounted on the corresponding one of the tab bundles 17B on the same side in the thickness direction of the electrode group 2 as other bonding plates 31B are mounted. In the example of FIG. 2, each of the bonding plates 31B is mounted on the corresponding one of the tab bundles 17B on the side of each of the bonding plates 31B being mounted on the corresponding tab bundles 17B according to the thickness direction of the electrode group 2 (the depth direction of the battery 1). The bonding plates 31B, whose number is the same as that of tab bundles 17B, are provided at positions deviated from each other in the thickness direction of the electrode group 2. In the examples of FIGS. 2 to 5, the bonding plates 31B are also separated from each other in the width direction of the electrode group 2.

The positive electrode-side lead 23A further includes a bridge plate 32A, and the bridge plate 32A of the positive electrode-side lead 23A bridges the bonding plates 31A, whose number matches that of the tab bundles 17A. Similarly, the negative electrode-side lead 23B includes a bridge plate 32B, and the bridge plate 32B of the negative electrode-side lead 23B bridges the bonding plates 31B, whose number matches that of the tab bundles 17B. The plate thickness direction is defined by the bridge plates 32A and 32B. Each of the bridge plates 32A and 32B has a pair of main surfaces, which face in mutually opposite sides in the plate thickness direction.

In the positive electrode-side lead 23A arranged in the interior cavity 8, the bridge plate 32A extends across different bonding plates 31A in such a manner that the plate thickness direction runs along the length direction of the electrode group 2 (height direction of the battery 1). Similarly, in the negative electrode-side lead 23B arranged in the interior cavity 8, the bridge plate 32B extends across the bonding plates 31B in such a manner that the plate thickness direction runs along the length direction of the electrode group 2 (height direction of the battery 1). A hole 33 is provided in each of the bridge plates 32A and 32B to penetrate through in the plate thickness direction. In each of the leads 23, the hole 33 penetrates through the bridge plate (corresponding one of 32A and 32B) along the length direction of the electrode group 2 (height direction of the battery 1).

The positive electrode-side lead 23A is connected to the positive electrode terminal 21A through the hole 33 of the bridge plate 32A, while the negative electrode-side lead 23B is connected to the negative electrode terminal 21B through the hole 33 of the bridge plate 32B. That is, each of the leads 23 is connected to the corresponding one of the electrode terminals 21 at the bridge plate (the corresponding one of 32A and 32B). The electrode terminals 21 are connected to the corresponding bridge plates 32A and 32B through any one of swaging, screwing, and laser-welding, or a combination thereof.

As described above, according to the present embodiment, the tab bundles 17A of the same polarity protrude from the electrode group 2 to the same side in the length direction of the electrode group 2. These tab bundles 17A are attached to the positive electrode-side lead 23A, which is one of the paired leads 23. With such an arrangement, the number of current collecting tabs 16 (positive electrode current collecting tabs 16A) to be stacked in each of the tab bundles 17A can be reduced. This reduction in the number of current collecting tabs 16 in each of the tab bundles 17A ensures the bondability of the tab bundles 17A to the positive electrode-side lead 23A. In a similar manner to the tab bundles 17A that constitute the positive electrode-side electric connection structure, the bondability to the negative electrode-side lead 23B can be ensured for the tab bundles 17B that constitute the negative electrode-side electric connection structure.

According to the present embodiment, the tab bundles 17A are attached to the positive electrode-side lead 23A at positions deviated from each other in the thickness direction of the electrode group 2. The tab bundles 17A are mounted on the positive electrode-side lead 23A on the same side relative to one another in the thickness direction of the electrode group 2.

In the operation of bonding each tab bundle 17A to the positive electrode-side lead 23A through ultrasonic welding or the like, an bonding tool is brought into contact with the tab bundle 17A from the side opposite to the side on which the corresponding one of the bonding attachment plates 31A of the positive electrode-side lead 23A is mounted in the thickness direction of the electrode group 2 (the stacking direction of the current collecting tabs 16). Then, a stage (anvil) is brought into contact with the corresponding bonding plate 31A of the positive electrode-side lead 23A from the side opposite to the side where the bonding tool is placed in the thickness direction of the electrode group 2, so that the tab bundle 17A and bonding plate 31A are held between the attaching tool and stage. With the tab bundle 17A and bonding plate 31A held between the bonding tool and stage, ultrasonic vibrations are applied to the tab bundle 17A by the bonding tool so as to bond the tab bundle 17A to the corresponding one of the bonding plates 31A.

As described above, the tab bundles 17A according to the present embodiment are mounted on the positive electrode-side lead 23A on the same side relative to one another in the thickness direction of the electrode group 2. For this reason, the positional relationship between the bonding tool and stage according to the thickness direction of the electrode group 2 in the operation of bonding one tab bundle 17A to the corresponding bonding plate 31A does not need to be reversed in the operation of bonding other tab bundles 17A to the positive electrode-side lead 23A. In this manner, the efficiency can be enhanced in the operation of bonding the tab bundles 17A to the positive electrode-side lead 23A. In a similar manner to the tab bundles 17A that constitute the positive electrode-side electric connection structure, the efficiency for the tab bundles 17B that constitute the negative electrode-side electric connection structure can be enhanced in the operation of bonding them to the negative electrode-side lead 23B.

Furthermore, according to the present embodiment, in each of the tab bundles (positive electrode-side tab bundles) 17A, the bonding portion to the positive electrode-side lead 23A is arranged within an area, in the thickness direction of the electrode group 2, where a connection portion C for connection with the electrode group 2 is formed. In this manner, the length of each tab bundle 17A between the connection portion C with respect to the electrode group 2 and the bonding portion with respect to the positive electrode-side lead 23A can be reduced. With the reduction in the length of the tab bundles 17A from the connection portion C with respect to the electrode group 2 to the bonding portion with respect to the positive electrode-side lead 23A, the current collecting tabs 16 (positive electrode current collecting tabs 16A) can be readily bundled. If the current collecting tabs 16 can be easily bundled in each of the tab bundles 17A, the tab bundles 17A can be readily bonded to the positive electrode-side lead 23A. In a similar manner to the tab bundles 17A that constitute the positive electrode-side electric connection structure, the current collecting tabs 16 (positive electrode current collecting tabs 16A) can be readily bundled, and can be readily attached to the negative electrode-side lead 23B for the tab bundles 17B that constitute the negative electrode-side electric connection structure.

According to the present embodiment, the bonding plates 31A of the positive electrode-side lead 23A are bonded to the corresponding tab bundles 17A in such a manner that the plate thickness direction runs along the thickness direction of the electrode group 2. In addition, the bridge plate 32A of the positive electrode-side lead 23A bridges the bonding plates 31A, the number of which matches that of the tab bundles 17A, in such a manner that the plate thickness direction runs along the length direction of the electrode group 2. The positive electrode terminal 21A is connected to the bridge plate 32A of the positive electrode-side lead 23A. In this manner, an electrical connection between the electrode group 2 and positive electrode terminal 21A can be suitably established in the structure in which the tab bundles 17A are bonded to the positive electrode-side lead 23A. In the same manner as in the positive electrode-side electric connection structure, an electrical connection between the electrode group 2 and negative electrode terminal 21B can be suitably established for the negative electrode-side electric connection structure in which the tab bundles 17B are bonded to the negative electrode-side lead 23B.

### (Modifications)

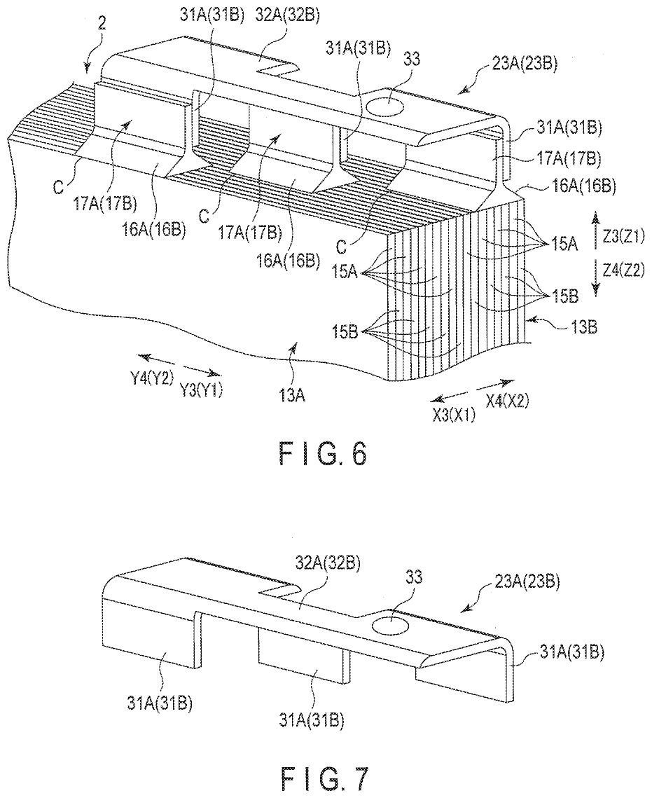

In the foregoing embodiment, two tab bundles 17A and two tab bundles 17B are formed. The number does not matter, however, as long as there are multiple tab bundles for each of 17A and 17B; three or more tab bundles may be formed. In the first modification of FIGS. 6 and 7, three tab bundles 17A of the same polarity protrude from the electrode group 2 to the same side in the length direction of the electrode group 2. These three tab bundles 17A are bonded to the positive electrode-side lead 23A at positions deviated from one another in the thickness direction of the electrode group 2 (the depth direction of the battery 1). In this modification, three bonding plates 31A are arranged in the positive electrode-side lead 23A so that the tab bundles 17A are attached to the corresponding bonding plates 31A in the same manner as in the foregoing embodiment. In this modification, the multiple (three) tab bundles 17A are mounted on the positive electrode-side lead 23A from the same side relative to one another in the thickness direction of the electrode group 2.

FIG. 6 is a perspective view schematically showing the structure of the bonding portions of multiple (three) tab bundles (17A or 17B) to one of the paired leads 23 and the vicinity of the bonding portions. FIG. 7 is a perspective view of one of the paired leads 23. According to this modification, three tab bundles 17B are formed in addition to the three tab bundles 17A, and three bonding plates 31B are formed in the negative electrode-side lead 23B. These three tab bundles 17B are bonded to the corresponding bonding plates 31B of the negative electrode-side lead 23B at positions deviated from one another in the thickness direction of the electrode group 2 (the depth direction of the battery 1). In the modification, the multiple (three) tab bundles 17B are mounted on the negative electrode-side lead 23B from the same side relative to one another in the thickness direction of the electrode group 2.

In the structure in which three or more tab bundles are formed for each of 17A and 17B as in this modification, operations and effects similar to those of the foregoing embodiment can be achieved. That is, for the structure in which three or more tab bundles 17A are provided, the three or more tab bundles 17A are mounted on the positive electrode-side lead 23A from the same side in the thickness direction of the electrode group 2 so that, in a manner similar to the foregoing embodiment, the efficiency can be enhanced in the operation of bonding the tab bundles 17A to the positive electrode-side lead 23A. Furthermore, in the structure in which three or more tab bundles 17B are provided, the three or more tab bundles 17B are mounted on the negative electrode-side lead 23B from the same side in the thickness direction of the electrode group 2 so that, in a similar manner to the foregoing embodiment, the efficiency can be enhanced in the operation of bonding the tab bundles 17B to the negative electrode-side lead 23B.

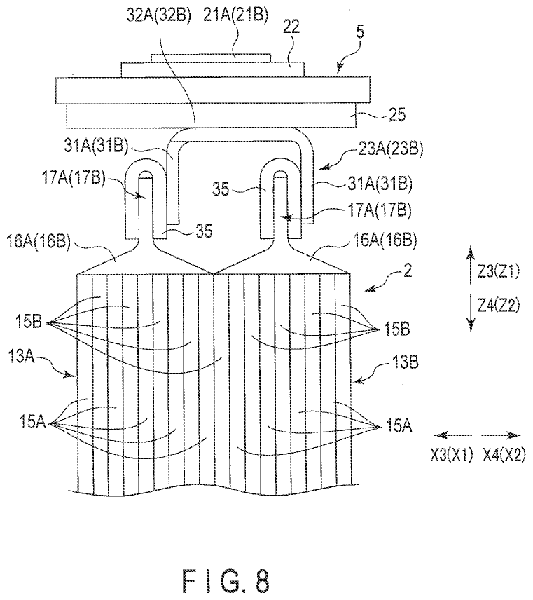

According to the foregoing embodiment, the tab bundles 17A and tab bundles 17B are bonded directly to either one of the paired leads 23. The tab bundles 17A and 17B, however, may be bonded to the corresponding leads 23 with a component interposed. In the second modification of FIG. 8, a clip plate (backup lead) 35 is attached to each of the tab bundles 17A so that each of the tab bundles 17A can be bonded to the positive electrode-side lead 23A with the clip plate 35 interposed. In the same manner, each of the tab bundles 17B is bonded to the negative electrode-side lead 23B with a clip plate 35 interposed. The clip plates 35 are formed of a conductive material such as a metal. FIG. 8 shows the structure of the electric connection of the electrode group 2 to one of the paired electrode terminals 21 and the vicinity of the electric connection. FIG. 8 schematically shows the state of the battery 1 when viewed from one side of the lateral direction of the battery 1 (length direction of the electrode group 2). Operations and effects similar to those of the foregoing embodiment can be achieved in this modification.

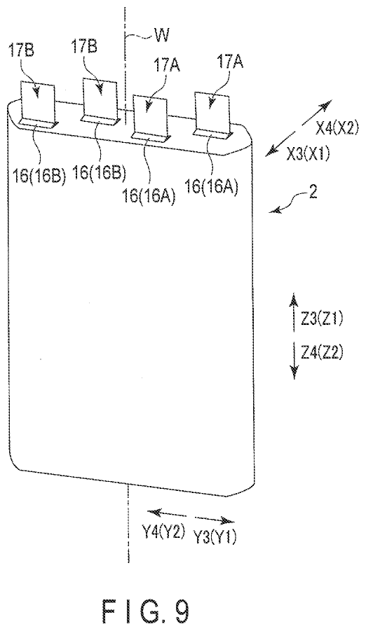

According to the foregoing embodiment, the electrode plates 15 (positive electrode plates 15A and negative electrode plates 15B) are stacked on the thickness direction of the electrode group 2 in the electrode group 2; however, the electrode group 2 is not limited to the aforementioned stacked structure. According to the third modification of FIG. 9, the electrode group 2 is formed into a wound structure. In the electrode group 2 according to this modification, the positive electrode and negative electrode are wound around a winding axis W. In the electrode group 2 of this modification, the positive electrode and negative electrode are electrically insulated from each other by a separator or the like. Furthermore, in the electrode group 2, the length direction, width direction, and thickness direction are defined in the same manner as in the foregoing embodiment. In this modification, the winding axis W runs along the length direction of the electrode group 2. FIG. 9 is a perspective view schematically showing the electrode group 2 and the current collecting tabs 16 protruding from the electrode group 2.

In this modification, the positive electrode current collecting tabs 16A form a plurality of tab bundles 17A of the same polarity, and the negative electrode current collecting tabs 16B form a plurality of tab bundles 17B of the same polarity. The tab bundles (positive electrode-side tab bundles) 17A are bonded to the positive electrode-side lead 23A at positions deviated from one another in the thickness direction of the electrode group 2 (the depth direction of the battery 1), and are mounted on the positive electrode-side lead 23A from the same side relative to one another in the thickness direction of the electrode group 2. The tab bundles (negative electrode-side tab bundles) 17B are bonded to the negative electrode-side lead 23B at positions deviated from one another in the thickness direction of the electrode group 2 (the depth direction of the battery 1), and are mounted on the negative electrode-side lead 23B from the same side relative to one another in the thickness direction of the electrode group 2. Thus, operations and effects similar to those of the foregoing embodiment can be achieved in this modification.

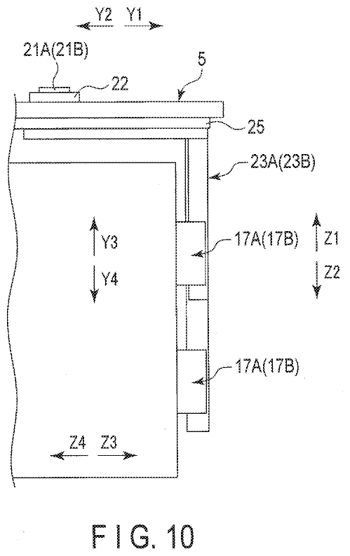

According to the foregoing embodiment, the tab bundles (negative electrode-side tab bundles) 17B protrude from the electrode group 2 on the same side as the protrusion of the tab bundles (positive electrode-side tab bundles) 17A according to the length direction of the electrode group 2, and the tab bundles 17A and 17B protrude toward the lid member 5 in the height direction of the battery 1. This is not a limitation, however. According to the fourth modification illustrated in FIG. 10, the tab bundles 17A protrude from the electrode group 2 toward one side in the length direction of the electrode group 2 (indicated by arrows Z3 and Z4). The tab bundles 17B protrude from the electrode group 2 to the other side in the length direction of the electrode group 2, which is opposite the side of the protrusion of the tab bundles 17A. In each of the tab bundles 17A and 17B, a plurality of current collecting tabs 16 are stacked in the thickness direction of the electrode group 2.

In this modification, the electrode group 2 is housed in the interior cavity 8 with its length direction matching the lateral direction (indicated by arrows Y1 and Y2) of the battery, and its width direction (indicated by arrows Y3 and Y4) matching the height direction of the battery 1 (indicated by arrows Z1 and Z2). This means that the tab bundles 17A protrude from the electrode group 2 to one side of the lateral direction of the battery 1, while the tab bundles 17B protrude from the electrode group 2 to the side opposite the protrusion of the tab bundles 17A in the lateral direction of the battery 1. In this modification, the thickness direction of the electrode group 2 agrees, or approximately agrees, with the depth direction of the battery 1. Thus, in each of the tab bundles 17A and 17B, the current collecting tabs 16 are stacked in the depth direction of the battery 1. FIG. 10 shows the structure of the electric connection of the electrode group 2 to one of the paired electrode terminals 21 and the vicinity of the electric connection. FIG. 10 schematically shows the state of the battery 1 when viewed from one side of the depth direction (the thickness direction of the electrode group 2).

In this modification, the tab bundles (positive electrode-side tab bundles) 17A are bonded to the positive electrode-side lead 23A at positions deviated from one another in the thickness direction of the electrode group 2 (the depth direction of the battery 1), and are mounted on the positive electrode-side lead 23A on the same side in the thickness direction of the electrode group 2. The tab bundles (negative electrode-side tab bundles) 17B are bonded to the negative electrode-side lead 23B at positions deviated from one another in the thickness direction of the electrode group 2 (the depth direction of the battery 1), and are mounted on the negative electrode-side lead 23B on the same side in the thickness direction of the electrode group 2. Thus, operations and effects similar to those of the foregoing embodiment can be achieved in this modification.

The exterior unit 3 is not limited to the aforementioned structure including the exterior container 4 and lid member 5. Any structure in which the electrode group is housed in the interior cavity of the exterior unit and a pair of electrode terminals are attached to the exterior unit in an externally exposing manner will be sufficient. To such a structure, the aforementioned electric connection between the paired electrode terminals and electrode group can be applied.

In the foregoing embodiment, the positive electrode-side electric connection structure between the positive electrode terminal and electrode group, and the negative electrode-side electric connection structure between the negative electrode terminal and electrode group have the same configuration; however, this is not a limitation. In a modification, only one of the paired electric connection structures may be formed in a manner similar to the corresponding one of the foregoing embodiment. In other words, a configuration having at least one of the paired electric connection structures formed in a manner similar to the foregoing embodiment will suffice.

According to at least one of the embodiment or examples, a battery includes a plurality of tab bundles protruding from the electrode group to the same side in the length direction of the electrode group, where the tab bundles demonstrate the same polarity. These tab bundles are bonded to the lead at deviated positions in the thickness direction of the electrode group, and are mounted on the lead from the same side in the thickness direction of the electrode group. Thus, with the configuration in which each of the tab bundles is constituted by the current collecting tabs of the same polarity, a battery with a high efficiency and firm bodability in bonding the tab bundles to the leads can be offered.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an exterior unit inside which an interior cavity is formed;
an electrode group including a positive electrode and a negative electrode, and being housed in the interior cavity of the exterior unit;
an electrode terminal attached to the exterior unit in such a manner as to be exposed to outside of the exterior unit;
a plurality of tab bundles, each of which includes a plurality of current collecting tabs, in each of which the current collecting tabs are stacked in a thickness direction of the electrode group, wherein the tab bundles demonstrate a same polarity and protrude from the electrode group to the same side in a length direction of the electrode group intersecting the thickness direction of the electrode group; and
a lead to which the tab bundles are respectively bonded, the lead being configured to establish an electric connection between the respective tab bundles and the electrode terminal in the interior cavity,
wherein the tab bundles are bonded to the lead at positions deviated from one another in the thickness direction of the electrode group, and each of the tab bundles is mounted on the lead on a same side in the thickness direction of the electrode group.

2. The battery according to claim 1, wherein
each of the tab bundles includes a connection portion for connection to the electrode group, the connection portion forming a base of a protruding portion that protrudes from the electrode group,
the connection portions of the tab bundles are formed in areas different from one another according to the thickness direction of the electrode group in the electrode group, and
a bonding portion for bonding to the lead is formed in each of the tab bundles within the area in which the connection portion for connection to the electrode group is formed according to the thickness direction of the electrode group.

3. The battery according to claim 1, wherein
the lead includes bonding plates corresponding to the respective tab bundles,
the bonding plates are respectively attached to the corresponding tab bundles in such a manner that a plate thickness direction runs along the thickness direction of the electrode group, and
the bonding plates provided in a same number of the tab bundles are arranged at positions deviated from one another in the thickness direction of the electrode group.

4. The battery according to claim 3, wherein
the lead includes a bridge plate configured to bridge the bonding plates, the number of which corresponds to that of the tab bundles, and
the bridge plate extends across the bonding plates in such a manner that the plate thickness direction runs along the length direction of the electrode group.

5. The battery according to claim 4, wherein
the electrode terminal is connected to the bridge plate of the lead.

6. The battery according to claim 1, wherein
the exterior unit includes:
an exterior container including a bottom wall and a peripheral wall, the interior cavity having an opening opened to a side opposite a side of the bottom wall; and
a lid member attached to the peripheral wall of the exterior container in such a manner as to close the opening of the interior cavity, the electrode terminal being attached to an outer surface of the lid member in such a manner as to be exposed to outside, and
each of the tab bundles protrudes from the electrode group toward the lid member.

7. The battery according to claim 1, wherein
the tab bundles are positive electrode tab bundles respectively connected to the positive electrode of the electrode group, and the respective positive electrode tab bundles are electrically connected to a positive electrode terminal, which serves as the electrode terminal, via a positive electrode-side lead, which serves as the lead, and/or
the tab bundles are negative electrode tab bundles respectively connected to the negative electrode of the electrode group, and the respective negative electrode tab bundles are electrically connected to a negative electrode terminal, which serves as the electrode terminal, via a negative electrode-side lead, which serves as the lead.
